(19) United States
(12) Patent Application Publication
(10) Pub. No.: US 2024/0083322 A1
(43) Pub. Date: Mar. 14, 2024

(54) AUTOMOBILE CONSOLE ORGANIZER TRAY

(71) Applicant: Guangzhou Yiliang Trading Co., Ltd., Guangzhou (CN)

(72) Inventor: Shuzhi CHEN, Wenzhou (CN)

(73) Assignee: Guangzhou Yiliang Trading Co., Ltd., Guangzhou (CN)

(21) Appl. No.: 17/930,423

(22) Filed: Sep. 8, 2022

(51) Int. Cl. B60N 3/00

(52) U.S. Cl. CPC B60N 3/002

(57) ABSTRACT

An automobile console organizer tray, includes a plurality of walls, a plurality of open space sections formed between the plurality of walls, and at least one arc-shaped section formed within the plurality of open space sections. The arc-shaped section is sized to accommodate small-sized objects, such as USB cables, necklaces, rings, coins for road tolls, mobile phones, and Bluetooth headsets; and the arc-shaped section has an arc-shaped bottom wall. The automobile console organizer tray has a special area for storing small-sized objects, such that small objects can be quickly found and taken out when these small objects are needed. The automobile console organizer tray is simple in structure, convenient to install, and easy to operate.

### TECHNICAL FIELD

The present disclosure relates to automobile parts, and in particular, to an automobile console organizer tray.

### BACKGROUND

With the development of society, nowadays almost every family owns a private car, and people are finding them more often to use this transportation tool. Correspondingly, a lot of objects need to be put in an automobile console organizer tray. However, most of the existing automobile console organizer trays on the market do not allow storage of small objects, such as USB cables, necklaces, rings, coins for road tolls, mobile phones, and Bluetooth headsets. In most cases, these objects are put into the automobile console organizer tray together with some other large objects. As a result, these small objects are more likely to be blocked by the larger ones, making them hard to find. This is annoying for many reasons. On one hand, a rummage may waste a lot of time; and on the other hand, delay in work or business may be caused when a small object urgently needed cannot be found in the first place. In view of the foregoing problem, the present disclosure provides an automobile console organizer tray, which allows for small objects to be stored in a specific storage area.

### SUMMARY

In view of the problem that small objects hidden in the large objects cannot be taken out of an existing automobile console organizer tray, an objective to be achieved by the present disclosure is to provide an automobile console organizer tray with a special storage area.

To achieve the above objective, the embodiments of the present disclosure provide an automobile console organizer tray, the automobile console organizer tray including a plurality of walls, a plurality of open space sections formed between the plurality of walls, and at least one arc-shaped section formed within the plurality of open space sections, where the arc-shaped section is sized to accommodate a coin, and has an arc-shaped bottom wall.

Preferably, at least one partition plate is further provided in the arc-shaped section to partition the arc-shaped section.

Preferably, the partition plate has an arc-shaped top.

Preferably, the partition plate and the arc-shaped section are integrally formed.

Preferably, the bottom wall of the arc-shaped section is in smooth transition with at least one side wall to form an arc-shaped structure that matches a structure of the coin.

Preferably, one or more concave grooves are formed in an outer wall of the automobile console organizer tray.

Preferably, at least one side wall of the outer wall of the automobile console organizer tray is a concave wall.

Preferably, the automobile console organizer tray is integrally formed.

Preferably, one or more of the plurality of open space sections are provided with holes at a bottom or side walls.

Preferably, an extension structure is provided at part or all of a top edge of the outer wall of the automobile console organizer tray.

The embodiments of the present disclosure have the following beneficial effects:
(1) The automobile console organizer tray described in the present disclosure has a particular arc-shaped section specially used for storing small objects, such as USB cables, necklaces, rings, coins for road tolls, mobile phones, and Bluetooth headsets, such that they can be stored at an obvious position and are easy to find.
(2) A particular partition plate is provided in a particular arc-shaped section of the automobile console organizer tray described in the present disclosure, and the bottom wall is of an arc-shaped structure that is in smooth transition with the side wall, such that objects like necklaces and rings that are likely to get caught in corners can be quickly taken out of the automobile console organizer tray.

### BRIEF DESCRIPTION OF THE DRAWINGS

To describe the technical solutions in the embodiments of the present disclosure or in the prior art more clearly, the following briefly describes the accompanying drawings required for describing the embodiments or the prior art. Apparently, the accompanying drawings in the following description show merely some embodiments of the present disclosure, and a person of ordinary skill in the art may still derive other drawings from these accompanying drawings without creative efforts.

FIG. 1 is a structural schematic diagram according to a first embodiment of the present disclosure;

FIG. 2 is a structural schematic diagram from another perspective according to a first embodiment of the present disclosure;

FIG. 3 is an enlarged view of an arc-shaped section according to a first embodiment of the present disclosure;

FIG. 4 is a structural schematic diagram according to a second embodiment of the present disclosure; and

FIG. 5 is a structural schematic diagram according to a third embodiment of the present disclosure.

### DETAILED DESCRIPTION OF THE EMBODIMENTS

The technical solutions of the embodiments of the present disclosure are clearly and completely described below with reference to the accompanying drawings. Apparently, the described embodiments are merely a part rather than all of the embodiments of the present disclosure. All other embodiments obtained by those of ordinary skill in the art based on the embodiments of the present disclosure without creative efforts shall fall within the protection scope of the present disclosure.

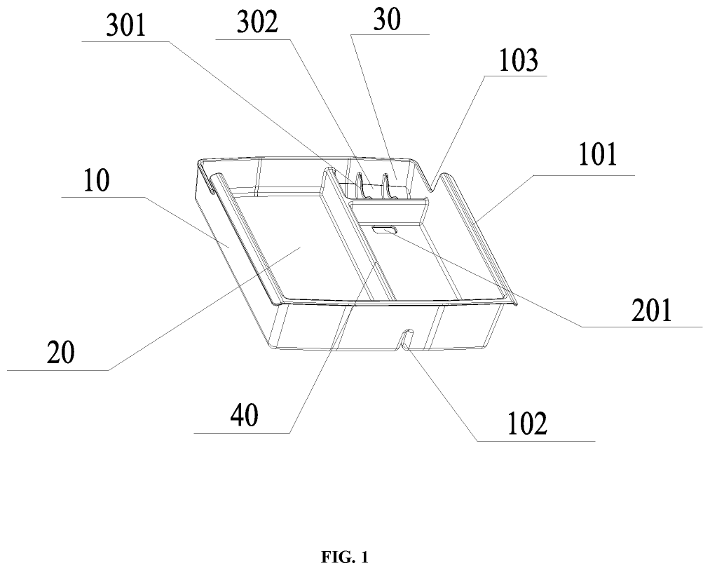

Referring to FIG. 1, an embodiment of the present disclosure provides an automobile console organizer tray, the automobile console organizer tray including an outer wall 10 of the automobile console organizer tray, a plurality of open space sections 20, an arc-shaped section 30, an inner wall 40 of the automobile console organizer tray, a top extension part 101, a bottom concave groove 102, a concave wall 103, a hole 201, a partition plate 301, and an arc-shaped bottom wall 302.

The outer wall 10 of the automobile console organizer tray refers to an outer frame structure of the automobile console organizer tray, whilst the inner wall 40 of the automobile console organizer tray refers to a grid barrier used to divide the internal space to form different open space sections. The plurality of open space sections 20 are formed by the connection between the outer wall 10 of the automobile console organizer tray and the inner wall 40 of the automobile console organizer tray or between every two inner walls 40 of the automobile console organizer tray. The arc-shaped section 30 is an open space area with a special structure in a plurality of open space sections 20; and the arc-shaped section 30 is formed by the connection of the arc-shaped bottom wall 302 in the outer wall 10 of the automobile console organizer tray, the outer wall 10 of the other automobile console organizer tray and the inner wall 40 of the automobile console organizer tray. The top extension part 101 refers to a part that extends outward from the top edge of the outer wall 10 of the automobile console organizer tray. The bottom concave groove 102 is generated after the bottom of the outer wall 10 of the automobile console organizer tray is recessed inward. The concave wall 103 is generated after a peripheral part of the outer wall 10 of the automobile console organizer tray is recessed downward. The hole 201 is a gap formed at the bottom of the open space area 20 or on the side wall. The partition plate 301 is a barrier plate provided inside the arc-shaped section 30. The arc-shaped bottom wall 302 is an arc-shaped wall at the bottom of the arc-shaped section 30.

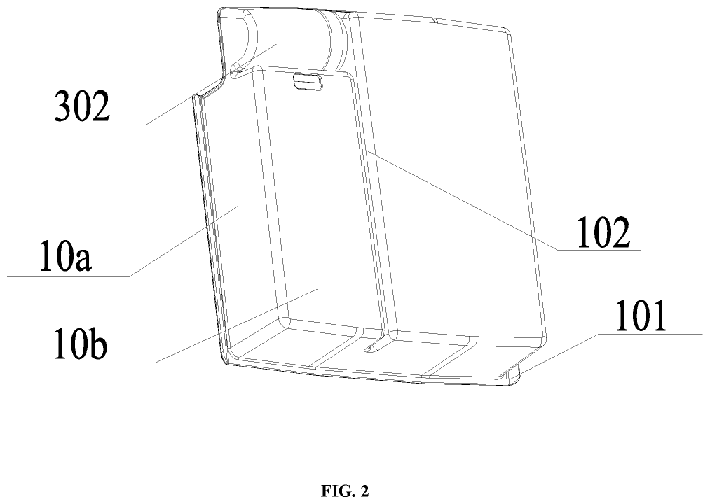

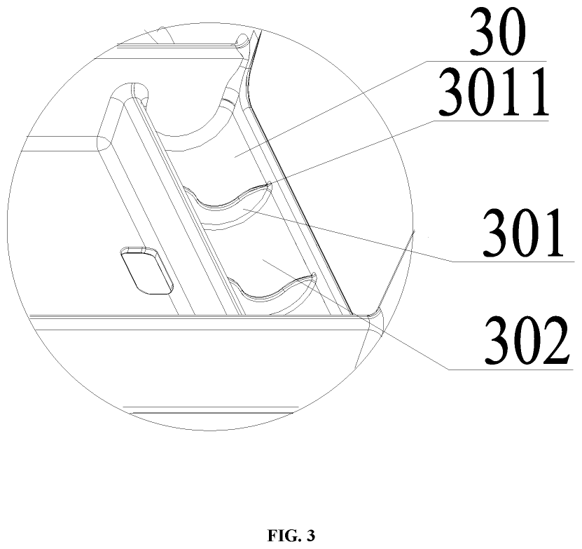

Referring to FIG. 1 and FIG. 2, the outer wall 10 of the automobile console organizer tray includes side walls 10a at the periphery and a bottom wall 10b. The outer wall 10 of the automobile console organizer tray is used for securing the automobile console organizer tray and supporting the open space sections 20 and the arc-shaped section 30; and the inner wall 40 of the automobile console organizer tray is a grid barrier for dividing the automobile console organizer tray into different open space sections. The plurality of open space sections 20 and the arc-shaped section 30 are used for providing storage space; as shown in FIG. 1, FIG. 2 and FIG. 3, the arc-shaped section 30 is specially used for storing small-sized objects, such as USB cables, candies, necklaces, rings, coins for road tolls, mobile phones, and Bluetooth headsets. The arc-shaped section 30 includes a partition plate 301 and an arc-shaped bottom wall 302. The partition plate 301 has an arc-shaped top 3011; and at least one partition plate is provided; the arc-shaped bottom wall 302 is of an arc-shaped structure; and the partition plate and the arc-shaped section 30 are integrally formed. When the arc-shaped section 30 is in use, as the arc-shaped bottom wall 302 is of an arc-shaped structure and the arc-shaped bottom wall 302 is in smooth transition with the side wall 10a, an arc-shaped structure is formed to match the structure of a coin. Therefore, small objects can be easily taken out when needed, and situations can be avoided that such objects can hardly be taken out due to sticking, rubbing, higher friction and other factors. In addition, objects with circular structures such as coins can be better stored and taken out. The width of the arc-shaped section 30 is between 2 cm-4 cm; the length can be determined according to the demand, the distance between every two adjacent partition plates 301 is 1 cm-3 cm, and the length can be increased by increasing the number of partition plates 301. The arc-shaped section 30 is partitioned into a number of cubicles by the partition plate 301 so as to make full use of and efficiently manage the space of the arc-shaped section 30, thereby ensuring that each object stored in the arc-shaped section 30 will not be obscured or mistakenly taken. The top of the partition 301 is an arc 3011, so the cubicles formed by the partition plate 301 will not be fully separated, rather, there exists a certain space for communication. When in use, due to the existence of the arc 3011, several adjacent cubicles can be used together to solve the problem that the arc-shaped section 30 cannot store a small object with a size between the size of the cubicle and that of the open space area 20 after the space of the cubicles is fixed. The partition plate 301 in the arc-shaped section 30 is integrated with the arc-shaped section 30, which greatly enhances the structural stability of the arc-shaped section 30 and ensures that the partition plate will not fall off and cause the object to be scattered and lost when the object is taken.

The open space sections 20 are used to store large-sized objects and objects that are less useful. The number of the open space sections 20 may be determined as required, and if there is a large space for the automobile console where the automobile console organizer tray of the present disclosure is located, more open space sections 20 can be set; and if it a single open space area 20 with a larger volume is required, fewer open space sections 20 are required. The several open space sections 20 are formed by the connection between the outer wall 10 of the automobile console organizer tray and the inner wall 40 of the automobile console organizer tray or between every two inner walls 40 of the automobile console organizer tray. The inner wall 40 of the automobile console organizer tray is formed after the bottom wall 10b in the outer wall 10 of the automobile console organizer tray is recessed inward, and a bottom concave groove 102 is formed on the outside of the automobile console organizer tray. The inner wall 40 of the automobile console organizer tray may vary in shape, and correspondingly, the shape of the open space area 20 is not fixed, which is conducive to the storage of various objects with different shapes. There is a hole 201 on the bottom wall 10b or side wall 10a of one or more open space sections 20 in the plurality of open space sections 20; and the shape and size of the hole 201 can be changed as necessary. The hole can be used to connect a power socket on the automobile console to realize the connection between a USB cable or an electric wire and the power socket on the automobile console without destroying the structural integrity of the automobile console organizer tray, thus preventing the structural strength of the automobile console organizer tray from being damaged. The hole enables the mobile phone to be charged quickly on the automobile, and allows for data exchange between the automobile and the mobile phone.

As a combination of the surrounding side walls 10a and the bottom wall 10b of the automobile console organizer tray, the outer wall 10 of the automobile console organizer tray is the main supporting structure of the automobile console organizer tray. The bottom concave groove 102 is formed on the outer wall 10 of the automobile console organizer tray, and is a space generated after the bottom wall 10b of the outer wall 10 of the automobile console organizer tray is recessed inward, the bottom concave groove 102 playing an important role in securing the automobile console organizer tray for the automobile console. In case an automobile shakes, vibrates, suddenly stops during a driving process, the bottom concave groove 102 can be well embedded in the automobile console to prevent relative motion between the automobile console organizer tray and the automobile console, thus stopping an object stored in the automobile console organizer tray from being scattered and damaged or preventing the scattered object from causing disturbance to the operation of the driver. There is also a top extension part 101 on the outer wall 10 of the automobile console organizer tray, which refers to a part that extends outward from the top edge of the side wall 10a of the outer wall 10 of the automobile console organizer tray. The top extension part 101 can help the bottom concave groove 102 to secure the automobile console organizer tray, and when the user takes the object in the automobile console organizer tray, the situation can be avoided that the user is harmed by a sharp edge. When the automobile console organizer tray is removed from the automobile console for maintenance or replacement, the top extension part 101 can well provide a force bearing point to help the user to safely and conveniently remove the automobile console organizer tray. At least one of side walls 10a of the outer wall 10 of the automobile console organizer tray has a concave wall 103, and the concave wall 103 is generated after the side wall 10a of the outer wall 10 of the automobile console organizer tray is recessed downward. The concave wall 103 is determined according to the different structure of the automobile console, and the concave wall 103 is conductive to help the bottom concave groove 102 to secure the automobile console organizer tray; and when a user takes or stores an object in the automobile console organizer tray, a lower platform is offered to help the user take or store the object. The outer wall 10 of the automobile console organizer tray, a plurality of open space sections 20, the arc-shaped section 30 and the inner wall 40 of the automobile console organizer tray are integrated, that is, the whole automobile console organizer tray is integrally formed. Such a structure is conducive to the stability of the structure of the automobile console organizer tray, and in the case of unexpected events (such as bumping and impact), the situation can be avoided that the automobile console organizer tray is broken and causes harm to the user; and the integrated automobile console organizer tray is convenient to disassemble and operate.

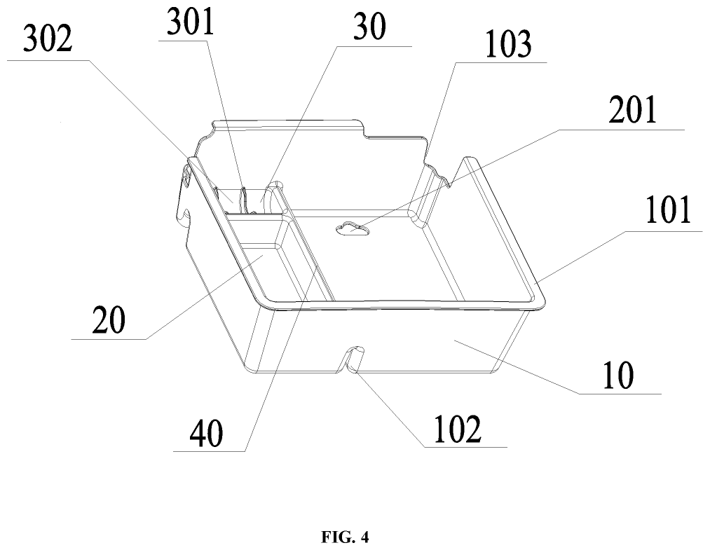

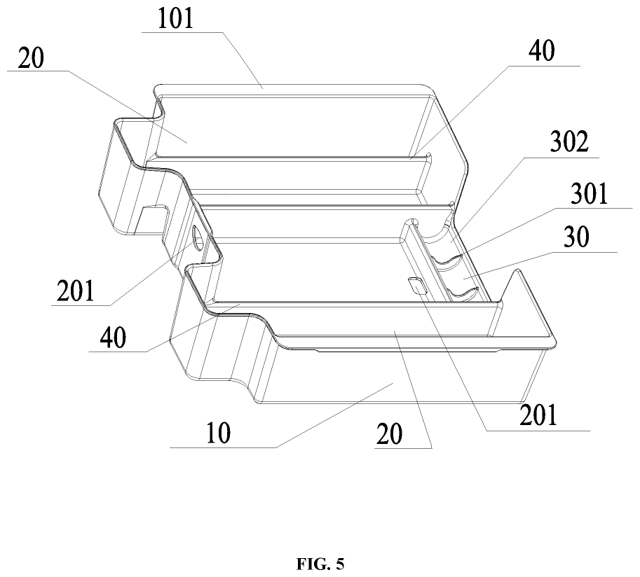

In addition to the first embodiment shown above, another two different embodiments are also provided in the present disclosure, as shown in FIG. 4 and FIG. 5. As shown in FIG. 4 and FIG. 5, there exists a difference in the concave wall 103 and the hole 201 between FIG. 4 and the first embodiment. In FIG. 5, there are a plurality of holes 201 and more open space sections 20 than in the first embodiment, and there is a non-rectangular open space area 20. Thus, it is further proved in the present disclosure that the shape of the concave wall 103 may be determined according to the different structures of an automobile console; the shape and size of the hole 201 can be changed as needed; and neither the number of the open space sections 20 nor the shape of the open space area 20 is fixed.

The above disclosed is merely a small part of preferred embodiments of the present disclosure, and definitely should not be used to limit the scope of the claims of the present disclosure. A person of ordinary skill in the art can understand all or some of the procedures for implementing the foregoing embodiments and make equivalent changes according to the claims of the present disclosure. The equivalent changes still fall within the scope of the present disclosure.

What is claimed is:

1. An automobile console organizer, comprising:
a plurality of walls,
a plurality of open space sections formed between the plurality of walls, and
at least one arc-shaped section formed within the plurality of open space sections, wherein the arc-shaped section is sized to accommodate coins, and has an arc-shaped bottom wall.

2. The automobile console organizer according to claim 1, wherein at least one partition plate is further provided in the arc-shaped section to partition the arc-shaped section.

3. The automobile console organizer according to claim 2, wherein the partition plate has an arc-shaped top.

4. The automobile console organizer according to claim 2, wherein the partition plate and the arc-shaped section are integrally formed.

5. The automobile console organizer according to claim 1, wherein the bottom wall of the arc-shaped section is in smooth transition with at least one side wall to form an arc-shaped structure that matches a structure of the coin.

6. The automobile console organizer according to claim 2, wherein one or more concave grooves are formed in an outer wall of the automobile console organizer.

7. The automobile console organizer according to claim 1, wherein at least one side wall of the outer wall of the automobile console organizer tray is a concave wall.

8. The automobile console organizer according to claim 1, wherein the automobile console organizer tray is integrally formed.

9. The automobile console organizer according to claim 1, wherein one or more of the plurality of open space sections are provided with holes at a bottom or side walls.

10. The automobile console organizer according to claim 1, wherein an extension structure is provided at part or all of a top edge of the outer wall of the automobile console organizer.
